(19) United States
(12) Patent Application Publication
(10) Pub. No.: US 2006/0095645 A1
(43) Pub. Date: May 4, 2006

(54) MULTI-FUNCTION CHIPSET AND RELATED METHOD

(76) Inventors: Chi-Hsing Lin, Taipei Hsien (TW); Chia-Hsing Yu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,726

(22) Filed: Jan. 18, 2005

(30) Foreign Application Priority Data
Nov. 3, 2004 (TW) 093133528

(51) Int. Cl. G06F 13/00

(52) U.S. Cl. 710/316

(57) ABSTRACT

Multi-function chipset and related design/manufacturing method for realizing different kinds of chipsets respectively supporting accelerated graphic port (AGP) bus and peripheral component interconnect extended (PCI-X) bus. The integrated circuit of the chipset includes both the AGP and PCI-X bus controllers, which share a common I/O pad configuration, and the chipset is selected to be an AGP-supported chipset or a PCI-X supported chipset by pin strapping. Also, the chipset can be packaged with different wire bonding configurations to alternatively realize chipsets supporting AGP bus or PCI-X bus.

### BACKGROUND OF INVENTION

1. Field of the Invention

The invention relates to a multi-function chip set and related design/manufacturing method, and more particularly, to a chip set and related design/manufacturing method capable of utilizing a single IC to implement chipsets with different functions.

2. Description of the Prior Art

Computer systems are the most important hardware foundation in today's modern information society. As the need for computer systems increases, demands of different users of the computer systems have become more apparent. In order to meet these demands, the information service provider discloses different related components of computer systems. As known by those skilled in the art, the computer system utilizes chipsets to manage/control data exchanges among the CPU, system memory, graphic acceleration cards, other cards/circuits, and peripheral devices. For example, the chip set is electrically connected to the graphic acceleration card through a bus of a specific standard in order to manage and control the data exchange between the graphic card and the CPU. In today's computer system, the graphic acceleration card of an AGP (accelerated graphic port) is often utilized. Therefore, in this type of computer system, a chipset that can support an AGP bus is utilized. On the other hand, for a network server computer system having a greater data flow and requiring a higher efficiency, the PCI-X bus is often utilized to connect the graphic card or other cards (such as a high-speed network card). Therefore, in a network server computer system, a chipset that can support a PCI-X bus has to be utilized.

In the prior art, the chipset for supporting the AGP bus and the chipset for supporting the PCI-X bus are separately designed and produced. In other words, the above-mentioned chipsets are designed through different ICs instead of the same circuit layout. Furthermore, time and cost involved in the semiconductor procedure of the two chipsets can not be reduced because different ICs need different masks, procedures, and packaging settings.

### SUMMARY OF INVENTION

The invention provides a technique of utilizing the same IC to respectively support chipsets with different functions so that the same IC can be utilized to support the chipset of both the AGP bus and the PCI-X bus, to solve the above-mentioned problem.

In the present invention, a chipset supporting two bus techniques is disclosed. The chip set comprises: a first bus controller for managing signal exchanging of a first bus technique; a second bus controller for managing signal exchanging of a second bus technique; and a multiplexer module comprising a plurality of multiplexers, wherein each input and output end of the first bus controller and the second bus controller is respectively connected to a corresponding input end of the corresponding multiplexer, and the multiplexer module manages the chip set to receive or transfer a signal of the first bus technique or the second bus technique according to a setting signal.

In the present invention, an AGP bus controller and a PCI-X bus controller are installed in the same IC. Furthermore, one of the two bus controllers can be enabled, and the other bus controller can be disabled. Therefore, the same IC can be utilized to selectively support the AGP bus or the PCI-X bus. Although the AGP bus and the PCI-X bus utilize different protocols and data structures, the standards/protocols of the two buses also have things in common. For example, the clock frequency of the data transmission of the two buses is the same (533 MHz). This represents that the two bus controllers can share some layout designs in the same IC (for example, the I/O pad layout).

As known by those skilled in the art, the clock frequency of each input/output signal of the input/output pad is one of the most important design considerations. Designers have to think about the clock frequency of the input/output signals, and then the designers can determine the spacing between two input/output pads, wire and layout configuration according to the above-mentioned clock frequency in order to prevent noises between input/output pads (for example, cross-talk or clock skew and jitter). In the present invention, the similar clock frequencies of the AGP and PCI-X buses are well utilized so that the two bus controllers can be integrated in the same IC and share the same layout of input/output pads. In a preferred embodiment of the present invention, a multiplexer module having at least one multiplexer is utilized to control electrical connections between the two bus controllers and the input/output pads. The multiplexer module can utilize the pin strapping technique to selectively connect one of the two bus controllers to the input/output pads so that the selected bus controller can work. At the same time, the unselected bus controller is disabled. Therefore, the same IC can achieve two chipsets supporting two different buses.

Because different chipsets can share the same IC design, production procedures, and packaging procedures, the present invention can reduce the time and cost of producing the chipset. Furthermore, because the layout area of input/output pad configuration of today's chipset is bigger than the layout area of the logic circuits of the IC, the layout area of input/output pads dominates the whole occupied layout area. Therefore, in the present invention, although two bus controllers are integrated in the same IC, the entire occupied area is not increased.

In another embodiment of the present invention, two bus controllers in the same IC can respectively utilize different input/output pads. In addition, when the IC is packaged, a different wire producing (wiring) procedure is utilized to electrically connect different bus controllers to the balls(or pins) on the substrate. Therefore, the same IC can be utilized to achieve chipsets supporting different buses.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a chipset of an embodiment according to the present invention.

FIG. 2 and FIG. 3 are diagrams illustrating the chip set shown in FIG. 1 utilized in different computer systems.

FIG. 4 is a diagram of another embodiment of utilizing a single IC to implement two chip sets having different functions.

### DETAILED DESCRIPTION

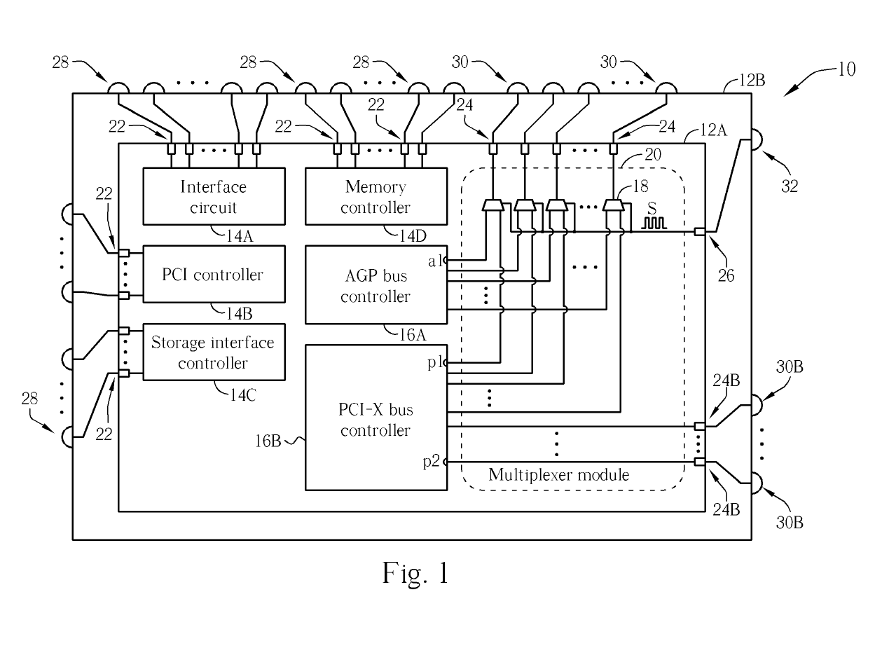

Please refer to FIG. 1, which is a diagram of a chipset 10 of an embodiment according to the present invention. The chipset 10 has an IC 12A with a packaging substrate 12B. The IC 12A comprises a peripheral component interconnect (PCI) controller for managing PCI buses, a storage interface controller 14C for controlling storage devices (for example, the hard disk or optical disk), a memory controller 14D for accessing memory, and an interface circuit 14A for managing the chipset 10 and the data exchange between the chipset 10 and the CPU. In addition, the IC 12A can selectively comprise an audio circuit for managing audio outputs, a display processing circuit for managing graphic signals, or a network controller. The above-mentioned circuits can receive/transfer signals or biases through the input/output pads 22 of the IC 12A. When the IC 12A is packaged on the packaging substrate 12B, the input/output pads 22 can be electrically connected to each corresponding ball (pin) 28 on the packaging substrate 12B through the wires between the IC 12A and packaging substrate 12B and the wire layout inside the packaging substrate 12B.

In addition to the above-mentioned circuit arrangement, in order to achieve the technique of the present invention, the present invention IC 12A further comprises an AGP bus controller 16A, a PCI-X bus controller 16B, and a multiplexer module 20. The AGP bus controller 16A (which can be regarded as a first bus controller) can manage signal exchange and data exchange among the devices connected to the AGP bus. Similarly, the PCI-X bus controller 16B (which can be regarded as a second bus controller) can manage signal exchange and data exchange among the devices connected to the PCI-X bus. The multiplexer module 20 can comprise a plurality of multiplexers 18. Each output end and input end of the two bus controllers 16A and 16B is electrically connected to a corresponding input/output pad 24 through a corresponding multiplexer 18. Furthermore, each input/output pad 24 is electrically connected to each corresponding ball 30 through the wire between the IC and the packaging substrate and the wire layout inside the packaging substrate. Under the above-mentioned arrangement, each multiplexer 18 can control the electrical connection between the input/output end of two bus controllers and corresponding input/output pad 24 (ball 30) according to a setting signal S.

For example, as shown in FIG. 1, the AGP bus controller 16A and PCI-X 16B bus controller both comprise an input/output end a1, p1, respectively, which are electrically connected to a corresponding multiplexer 18. When the multiplexer 18 receives a setting signal S having a specific content (for example, a high-level DC signal), the multiplexer 18 establishes the electrical connection between the input/output end al of the AGP bus controller 16A and corresponding input/output pad 24 (and ball 30), and the multiplexer 18 breaks the connection between the input/output end p1 of the PCI-X bus controller 16B and corresponding input/output pad 24 (and ball 30). In the other situation, when the multiplexer 18 receives a setting signal S having another specific content (for example, a low-level DC signal), the multiplexer 18 establishes the electrical connection between the input/output end p1 of the PCI-X bus controller 16B and corresponding input/output pad 24 (and ball 30), and the multiplexer 18 breaks the connection between the input/output end al of the AGP bus controller 16A and corresponding input/output pad 24 (and ball 30). Therefore, because of the operations of the multiplexers 18 of the multiplexer module 20, the AGP bus controller 16A and the PCI-X bus controller 16B can be selectively utilized to receive/transfer signals through each input/output pad 24 and ball 30. These balls can be regarded as the bus balls of the AGP bus or the PCI-X bus.

In other words, if the present invention needs the chipset 10 to achieve the chipset supporting AGP bus, the present invention can utilize the multiplexer module 20 to make the AGP bus controller 16A transfer/receive signals through the input/output pads 24 and balls 30. Therefore, the AGP bus controller 16A is able to work but the PCI-X bus controller 16B is unable to work, because the connection between the PCI-X bus controller 16B, the input/output pads 28 and balls 30 is broken by the multiplexer module 20. Oppositely, if the same chipset 10 has to be utilized to achieve a chipset of PCI-X bus, the multiplexer module 20 can be utilized to make the PCI-X bus controller 16B receive/transfer signals from the input/output pads 24 and balls 30. Therefore, in this situation, the PCI-X bus controller 16B is able to work. The AGP bus controller 16A, however, is unable to work because the connection between the AGP bus controller 16A, the input/output pads 28 and balls 30 is broken by the multiplexer module 20. In the practical implementation, the present invention can utilize the operation of the multiplexer module 20 to disable the bus controller, which is not connected to the input/output pads 28 and balls 30. For example, the multiplexer module 20 can make the bus controller, which is not connected to the input/output pads 28 and balls 30, be unable to get power. This is achieved by the multiplexer module 20 breaking the electrical connection between the above-mentioned bus controller and the power wire (such as power plane) of the IC. Oppositely, another bus controller, which is electrically connected to the input/output pads 28 and balls 30, is able to work because the power is supplied and it can receive/transfer signals through connected input/output pads 28 and balls 30.

Furthermore, the setting signal S can be received by the input/output pads 26 and the corresponding ball 32 (as shown in FIG. 1) from external circuits outside the chipset 10. In other words, the ball 32 can be utilized as a multiple setting ball so that the user can utilize a pin strapping method to select whether the chipset 10 supports the AGP standard or PCI-X standard. For example, when the user connects the multiple setting ball 32 of the chipset 10 to a high-level DC voltage, this represents that the multiplexer module 20 receives a high-level setting signal. Therefore, the multiplexer module 20 can enable one of the AGP and PCI-X bus controllers and allow the enabled bus controller to transfer/receive signals through corresponding input/output pad 24 and corresponding ball 30. The enabled bus controller is now able to work. Furthermore, in some pin strapping methods, a chip can utilize a specific pin to receive the setting signal only when the chip is in a specific mode (for example, an initial set-up or boot mode). When the chip is in a normal operation mode, the specific pin is utilized as a normal input/output pin instead of a strapping pin. In the present invention, this pin-strapping setting technique can be utilized to control the function of the multiplexer module 20. For example, the multiplexer module 20 can comprise a setting signal register. The setting signal register can be electrically connected to the multiple setting ball 32 when the chipset 10 is operated in the initial set-up mode (for example, the computer system is booting) for receiving the setting signal from external circuits (such as a motherboard) through the ball 32 to determine whether the chipset 10 supports the AGP or PCI-X bus. Until the chipset 10 is in the normal operation mode (for example, the computer system is already booted), each multiplexer 18 of the multiplexer module 20 can determine which bus controller is enabled and connected to each ball according to the setting signal stored in the setting signal register. Furthermore, the ball 32 can be separated outside the register and switched to connect to other controllers of the chipset 10 so that the ball 32 becomes a normal signal input/output ball. In other words, in a normal operation mode, the multiplexer module 20 does not change the electrical connection of the bus controller according to the signal of the ball 32 anymore.

As mentioned above, in the embodiment shown in FIG. 1, the AGP bus controller and PCI-X bus controller can share the same input/output pads configuration through the arrangement of the multiplexer module 20. Because the AGP and PCI-X buses are both based on the PCI bus, the standards of the AGP and PCI-X buses have many similar signals. For example, IRDY, TRDY, Frame, and other signals are all defined in the standards of both the AGP and PCI-X buses. The present invention utilizes the above-mentioned characteristic to make the two bus controllers share the same input/output pads configuration. Furthermore, the clock frequencies of signal transmission in the AGP and PCI-X bus standards are very close (in fact, the clock frequency is 533 MHz, but a small acceptable inaccuracy may occur). As known by those skilled in the art, the clock frequency of the signal transmission is one of the most important design configurations. The clock frequency influences the wire, spacing, or other settings. Therefore, different input/output pads configurations are used in order to transfer signals with different clock frequency. However, because the clock frequencies in the AGP and PCI-X bus standards are close, the AGP and PCI-X bus controllers can easily share most of the input/output pads configurations. The present invention utilizes the above-mentioned characteristic to integrate the two bus controllers in the same IC.

In addition, in today's IC design for the chipsets, the layout area is dominated by the input/output pads configuration. That is, the occupied area of all controllers is smaller than the total area of the IC. It implies that, since the input/output pads configuration dominates total area of an IC, no matter how small the area of the controller is, the total area of the IC can not be reduced. Considering the present invention, because the AGP and PCI-X bus controllers can share the same input/output pads configurations, the two bus controllers can be integrated in the same IC without increasing the occupied area. In other words, even in the present invention chipset comprising AGP and PCI-X bus controllers, the occupied area of the two bus controllers is still smaller than the occupied area of the input/output pads configuration. Therefore, as long as the occupied area of the input/output pads configuration is not increased, the whole area of the IC is not increased.

In the AGP and PCI-X bus standards, the number of needed signals may be different. For example, because the PCI-X bus utilizes a 64-bit signal transmission, the bus controller may need more input/output pads and balls to transfer/receive more signals/data. As shown in FIG. 1, the additional input/output pads and balls can be achieved by the input/output pads 24B and balls 30B. Therefore, if the chipset 10 is utilized as a PCI-X bus controller chipset, the PCI-X bus controller 16B of the chipset 10 can utilize the balls 30 and 30B to transfer/receive signals. Oppositely, if the chipset 10 is utilized as an AGP bus controller chipset, the balls 30B can be unused balls.

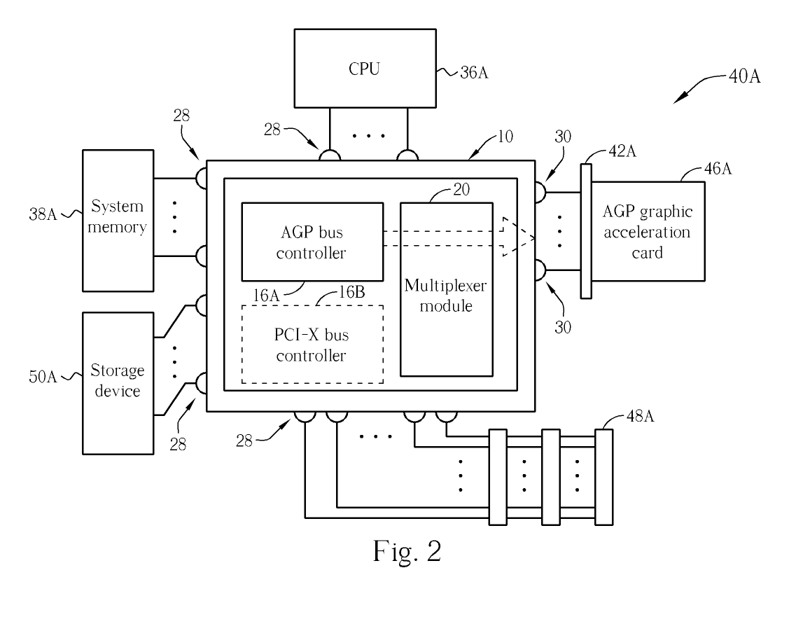

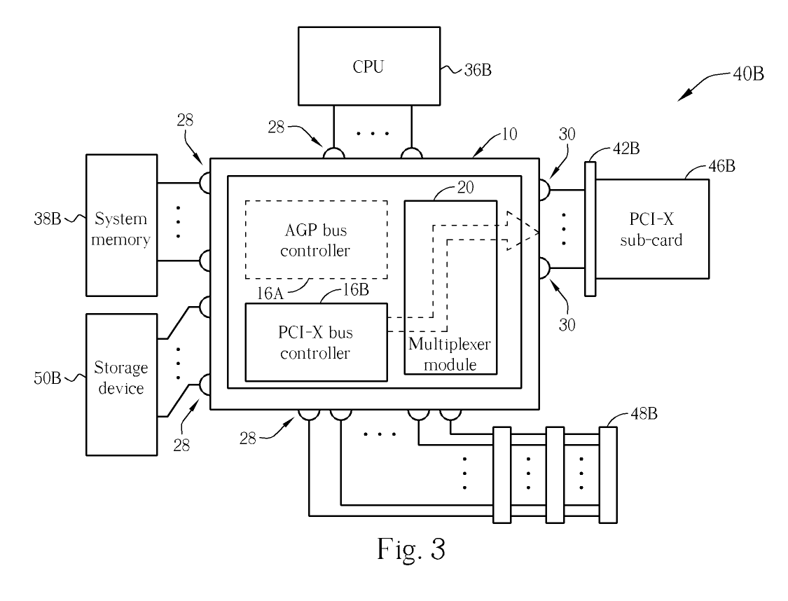

Please refer to FIG. 2 and FIG. 3 in conjunction with FIG. 1. FIG. 2 and FIG. 3 are diagrams illustrating the chipset 10 shown in FIG. 1 utilized in different computer systems. In order to illustrate this more clearly, some circuits of the chipset 10 are omitted in FIG. 2 and FIG. 3. As shown in FIG. 2, the computer system 40A can be a personal computer. Through an appropriate pin strapping setting of the multiplexer module 20, the multiplexer module 20 can disable the PCI-X bus controller 16B and enable the AGP bus controller 16A of the chipset 10. Therefore, the AGP bus controller 16A can be electrically connected to an AGP slot 42A through each ball 30. Through the AGP slot 42A, the chipset 10 can achieve the control function of the AGP bus controller to become a chipset supporting the AGP bus. This means the chipset 10 can manage the device on the AGP bus (for example, the AGP graphic acceleration card 46A). Furthermore, other balls 28 of the chipset 10 can be respectively connected (for example, the balls can be electrically connected through the wire layout of the motherboard) to a CPU 36A, a system memory 38A (such as DRAM), one or more storage devices (such as hard disks) 50A, and one or more slots 48A (such as the PCI bus slot) to manage signal exchanges among the CPU 36A, the system memory 38A, the AGP device, the PCI device (for example, network card, sound card), and other storage devices.

As shown in FIG. 3, the computer system 40B can be a high-speed network server. Therefore, the computer system 40B needs a chipset supporting a high-speed PCI-X bus. Through an appropriate pin strapping setting of the multiplexer module 20, the multiplexer module 20 can enable the PCI-X bus controller 16B and disable the AGP bus controller 16A. Furthermore, the PCI-X bus controller 16 can be electrically connected to one or more PCI-X slots through the balls 30 (and 30B) to achieve a chipset supporting the PCI-X bus. So the chipset 10 can manage the device on the PCI-X slot. For example, the device can be a PCI-X add-in card 46B (such as a PCI-X graphic acceleration card or a high-speed network card). Other balls 28 of the chipset 10 can be respectively connected to a CPU 36B, a system memory 38B, one or more storage devices 50B, and slots 48B (such as PCI slots) in order to manage signal exchanges among the CPU 36A, the system memory 38A, the PCI-X device, the PCI device, and other storage devices (such as hard disks).

From the above-mentioned discussion, the present invention can utilize the same chipset to achieve two chipsets, which respectively support AGP and PCI-X buses. In other words, the present invention only has to design, produce, and develop a single chipset. The chipset can be utilized as a multi-function chipset to achieve different functions. Therefore, the cost and time involved in production/development of the chipset can be reduced.

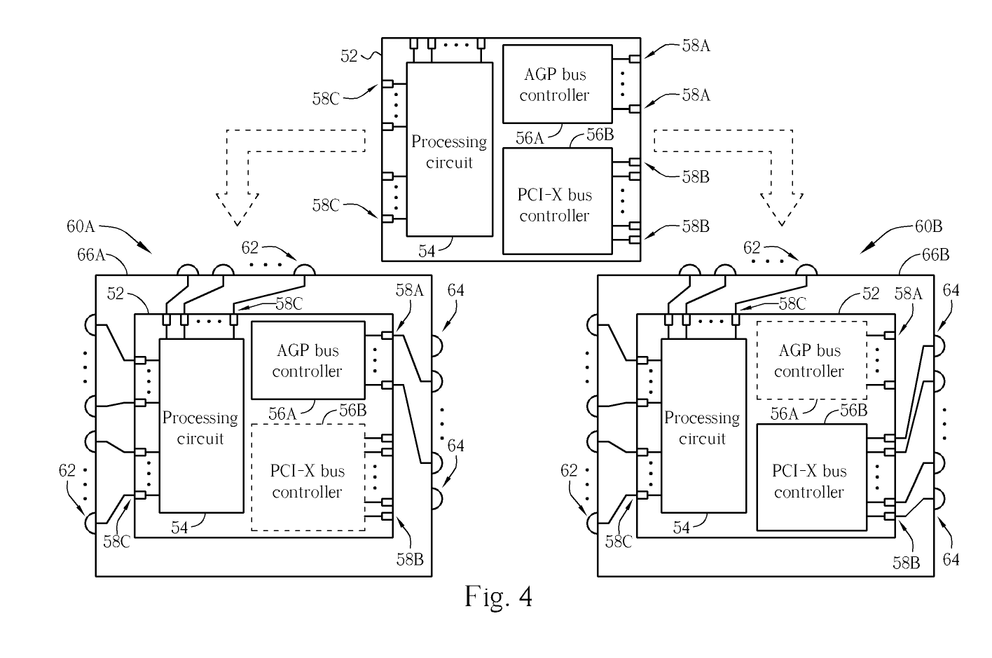

Please refer to FIG. 4, which is a diagram of another embodiment utilizing a single IC 52 to implement two chipsets having different functions. The IC 52 can comprise a processing circuit 54, an AGP bus controller 56A, and a PCI-X bus controller 56B. The processing circuit 54 not only comprises many types of interface circuits and controllers, such as the circuits 14A to 14D shown in FIG. 1, but also comprises audio circuits, display processing circuits, and network controlling circuits. In addition, the processing circuit 54 can transfer/receive signals through each input/output pad 58C of the IC 52. The AGP bus controller 56A can transfer/receive signals to manage and control the devices on the AGP bus through each input/output pad 58A. The PCI-X bus controller 56B can transfer/receive signals through each input/output pad 58B to control and manage the devices on the PCI-X bus. In other words, in the IC 52, the AGP bus controller and the PCI-X bus controller respectively have their own input/output pads 58A and 58B.

In this embodiment, if the IC 52 has to be utilized as a chipset 60A supporting the AGP bus controller 60A, each input/output pad 58A of the AGP bus controller 56A has to be electrically connected to each ball 64 (the bus ball) of the substrate 66A when the IC 52 is being packaged. Therefore, the AGP bus controller 56A can transfer/receive signals through the input/output ports 58A and balls 64 to achieve the control function of the AGP bus. Oppositely, each input/output pad of the PCI-X controller 56B is not electrically connected to each ball at this time. In other words, the PCI-X controller 56B does not work. Furthermore, the input/output pads 58C of the processing circuit 54 are electrically connected to the corresponding balls 62 when the IC is being packaged.

On the other hand, if the IC 52 has to be utilized as a chipset 60B supporting the PCI-X bus controller 60B, each input/output pad 58B of the PCI-X bus controller 56B has to be electrically connected to each ball 64 (the bus ball) of the substrate 66B when the IC 52 is being packaged. Therefore, the PCI-X bus controller 56B can transfer/receive signals through the input/output ports 58B and balls 64 to achieve the control function of the PCI-X bus. Oppositely, each input/output pad of the AGP controller 56A is not electrically connected to each ball at this time. In other words, the AGP controller 56A does not work. Furthermore, the input/output pads 58C of the processing circuit 54 are electrically connected to the corresponding balls 62 when the IC is being packaged. Please note that the substrate 66A can be the same as the substrate 66B.

As mentioned above, in the embodiment shown in FIG. 4, the same IC (even the IC utilizing the same substrate) is utilized to achieve two functions (AGP bus controller and PCI-X bus controller) through different packaging methods. In other words, the IC can support both the AGP and PCI-X buses.

In contrast to the prior art, the present invention can utilize the same IC (and also the same substrate and the same packaging procedure such as in the embodiment shown in FIG. 1) to support AGP and PCI-X buses. Therefore, the present invention can reduce the cost and time involved in production of the chipset and can be utilized in different computer systems.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A chipset supporting two bus techniques, the chip set comprising a first bus controller for managing signal exchanging of a first bus technique;
a second bus controller for managing a signal exchanging of a second bus technique; and
a multiplexer module comprising a plurality of multiplexers, wherein each input and output end of the first bus controller and the second bus controller is respectively connected to a corresponding input end of the corresponding multiplexer, and the multiplexer module manages the chip set to receive or transfer a signal of the first bus technique or the second bus technique according to a setting signal.

2. The chip set supporting two bus techniques of claim 1 further comprising a plurality of bus balls respectively connected to output ends of the multiplexers as connections between the first bus controller and the chip set or between the second bus controller and the chip set.

3. The chip set supporting two bus techniques of claim 1 further comprising a multiple setting ball connected to the multiplexer module and an external circuit outside the chip set for generating the setting signal to the multiplexer module according to a bus of the external circuit.

4. The chip set supporting two bus techniques of claim 3, wherein the multiple setting ball is capable of making the chip set utilize a pin connection method to choose supporting the signal of the first bus technique or the second bus technique.

5. The chip set supporting two bus techniques of claim 4, wherein when the chip set is turned on, the chip set determines to support the first bus technique or the second bus technique according to the external circuit.

6. The chip set supporting two bus techniques of claim 5, wherein the multiplexer module comprises a setting signal register connected to the multiple setting ball for receiving the setting signal.

7. The chip set supporting two bus techniques of claim 1, wherein when the chip set receives the setting signal to choose to support the first bus technique, the chip set enables the first bus controller instead of enabling the second bus controller.

8. The chip set supporting two bus techniques of claim 1, wherein when the chip set receives the setting signal to choose to support the second bus technique, the chip set enables the second bus controller instead of enabling the first bus controller.

9. The chip set supporting two bus techniques of claim 1, wherein the first bus technique is a bus technique of an AGP standard.

10. The chip set supporting two bus techniques of claim 1, wherein the second bus technique is a bus technique of a PCI-X standard.

11. A chip set supporting two bus techniques, the chip set comprising:
a first bus controller for managing a signal exchanging of a first bus technique;
a second bus controller for managing a signal exchanging of a second bus technique; and
a plurality of bus balls for allowing the chip set to connect to an external circuit;
wherein when the chip set chooses to support the first bus technique, the bus balls receive or transfer input/output control signals of the first bus controller; and when the chip set chooses to support the second bus technique, the bus balls receive or transfer input/output control signals of the second bus controller.

12. The chip set supporting two bus techniques of claim 11 further comprising a multiplexer module comprising a plurality of multiplexers for managing to receive or transfer signals of the first bus technique or the second bus technique according to a setting signal;
wherein input ends of the multiplexers are respectively connected to the first bus controller and the second bus controller.

13. The chip set supporting two bus techniques of claim 12 further comprising a multiple setting ball connected to the multiplexer module and an external circuit outside the chip set for generating the setting signal according to the bus of the external circuit.

14. The chip set supporting two bus techniques of claim 13, wherein the multiple setting ball is capable of making the chip set utilize the pin connection method to choose to support the first bus technique or the second bus technique.

15. The chip set supporting two bus techniques of claim 14, wherein the multiplexer module comprises a setting signal register connected to the multiple setting ball for receiving the setting signal.

16. The chip set supporting two bus techniques of claim 12, wherein when the chip set receives the setting signal to choose to support the first bus technique, the chip set enables the first bus controller instead of enabling the second bus controller.

17. The chip set supporting two bus techniques of claim 12, wherein when the chip set receives the setting signal to choose to support the second bus technique, the chip set enables the second bus controller instead of enabling the first bus controller.

18. The chip set supporting two bus techniques of claim 11, wherein the first bus technique is a bus technique of an AGP standard.

19. The chip set supporting two bus techniques of claim 11, wherein the second bus technique is a bus technique of a PCI-X standard.

20. A chip set supporting a plurality of bus techniques, the chip set comprising:
a plurality of bus controllers, wherein each bus controller respectively manages a bus technique; and
a multiplexer module comprising a plurality of multiplexers for managing the chip set to receive or transfer one of the signals of the bus techniques according to a setting signal;
wherein input ends of the multiplexers are respectively connected to the bus controllers.

21. The chip set supporting a plurality of bus techniques of claim 20 further comprising a plurality of bus balls respectively connected to output ends of the multiplexers for connecting to other external circuits of the chip set.

22. The chip set supporting a plurality of bus techniques of claim 20 further comprising at least a multiple setting ball connected to the multiplexer module and an external circuit of the chip set for generating the setting signal according to the bus of the external circuit.

23. The chip set supporting a plurality of bus techniques of claim 22, wherein the multiple setting ball is capable of making the chip set utilize a pin connection method to choose to support one of the bus techniques.

24. The chip set supporting a plurality of bus techniques of claim 23 wherein the multiplexer module comprises a setting signal register connected to the multiple setting ball for receiving the setting signal.

25. The chip set supporting a plurality of bus techniques of claim 20, wherein when the chip set receives the setting signal to choose to support one of the bus techniques, the chip set enables the selected bus controller instead of enabling other bus controllers.
